(19) United States
(12) Patent Application Publication
(10) Pub. No.: US 2019/0018979 A1
(43) Pub. Date: Jan. 17, 2019

(54) PROTECTION OF PRIVATE INFORMATION THROUGH PRIVACY-CENTRIC STORAGE AND PROCESSING

(71) Applicant: InterDigital Patent Holdings, Inc., Wilmington, DE (US)

(72) Inventors: Alec BRUSILOVSKY, Downingtown, PA (US); Yogendra C. SHAH, Exton, PA (US)

(21) Appl. No.: 16/067,367

(22) PCT Filed: Dec. 29, 2016
(86) PCT No.: PCT/US2016/069189

§ 371 Date: Jun. 29, 2018

Related U.S. Application Data
(60) Provisional application No. 62/276,616, filed on Jan. 8, 2016.

(51) Int. Cl. G06F 21/62; H04L 29/06; G06Q 40/02; H04W 12/02; H04W 12/08

(52) U.S. Cl. CPC G06F 21/6245; H04L 63/10; H04L 67/10; H04W 12/02; H04W 12/08; G06Q 40/025

(57) ABSTRACT

In this disclosure, various issues related to data (information) privacy are addressed. For example, in an example embodiment, privacy and confidentiality of data is maintained while being consumed by a third party entity. As described herein, an entity may be able to perform secure and trustworthy operations, such as various computations and algorithmic functions for example, on private data without having direct access to the data, thereby protecting the data.

### BACKGROUND

This application claims the benefit of U.S. Provisional Patent Application Ser. No. 62/276,616 filed Jan. 8, 2016 the content of which is hereby incorporated by reference as if set forth in its entirety.

Traditionally, confidential and private information is collected from users and entities, and then forwarded to one or more entities for consumption. Examples of confidential and private information include identity-related authentication or authorization credentials, personal financial information, credit card information, social security numbers, etc. User authentication credentials are often obtained from a user and forwarded to an entity that is controlled by the authenticator or its agent. For example, a mobile management entity (MME) is an authenticator on behalf of a home location register or home subscriber server (HLR/HSS) in a traditional mobile operator 4G Evolved Packet System (EPS) architecture. Similarly, personal user information is often forwarded to a credit rating agency for authorization purposes (e.g., issuance of credit, check of creditworthiness, etc.).

Thus, confidential and private information is often collected from the entity that is seeking to be authenticated or authorized. The entity may be a person, equipment, a subscriber to a mobile network operator (MNO), a user equipment, or the like. The information may be forwarded to a third party, and then processed to arrive at an authorization decision. In such authentication and authorization systems, the verification of the submitted private and personal information may be performed by verification entities that belong to different administrative and ownership domains as compared to the entity that is being authentication or authorized. Often the entity that is being authenticated and/or authorized has to share private and confidential information with the verification entity. In some cases, security and privacy of such confidential information can be protected for the entity seeking authentication or authorization (e.g., via EPS AKA, hashed passwords, credit card tokenization, etc.). In other cases, however, such private or confidential information has to be shared. By way of example, social security numbers, addresses, birth dates, answers to challenge-response questions for login password resets, credit card information, or the like, may be required to be shared. The nature of such private/confidential information is such that upon sharing with another entity, the information ceases to be private/confidential, because there is no guarantee or control on the information to ensure that the information will be consumed and discarded securely. In some cases, data may even be stored at these third parties, creating further vulnerabilities to the data.

In this disclosure, embodiments are described that address the above-described privacy-related concerns, among others.

### SUMMARY

In this disclosure, embodiments are described that address various issues related to data privacy. For example, in an example embodiment, privacy and confidentiality of data is maintained while being consumed by a third party entity. As described herein, an entity may be able to perform secure and trustworthy operations, such as various computations and algorithmic functions for example, on private data without having direct access to the data.

In an example embodiment, a node comprises a processor and a memory, and the memory contains computer-executable instructions that when executed by the processor, cause the processor to perform various operations. For example, the node may receive a request, from a network entity, for a result that requires at least one processing function to be performed on data. In some cases, at least some of the data is stored on a data node, and the data that is stored on the data node is controlled by a plurality of control nodes, such that each control node controls a respective portion of the data. The node may further receive a respective processing function from each of the plurality of control nodes. Each processing function may be associated with a respective control node. The node may perform each of the processing functions on the respective portion of data that is controlled by the control node associated with the processing function. The node may determine a result based on the processing functions, and send the result to the network entity. The processing functions may include at least one of a Java Applet, a remote procedure call, or a virtual network function.

In one example embodiment, a node is communicatively coupled with a network via its communication circuitry. The node, for instance a user equipment (UE), further comprises a processor and a memory, the memory containing computer-executable instructions that when executed by the processor, cause the processor to perform operations. The operations include receiving data and sending an authorization request to a second node in the network without sending the data to the second node. Based on the authorization request, the node receives a virtual authorization function, and computes an authorization assertion using the virtual authorization function and the data. The data may be private or confidential information received from a user of the node. For example, the authorization assertion may indicate the result of a credit check.

In another example embodiment, a node receives one or more authentication credentials. Based on the authentication credentials, the node sends a policy request to a second node, such that the second node does not receive the authentication credentials. The node receives a policy in response to the policy request. Based on the policy, the node generates an authentication function for a user device to perform authentication without sharing the authentication credentials with the second node.

### BRIEF DESCRIPTION OF THE DRAWINGS

A more detailed understanding may be had from the following description, given by way of example in conjunction with the accompanying drawings wherein:

FIG. 1 is a call flow that depicts an example of a conventional information flow for a credit check;

FIG. 2 is a call flow that illustrates an information flow for an example credit check, in accordance with an example embodiment in which an attack surface is reduced as compared to the attached surface of the information flow depicted by FIG. 1;

FIG. 3 is a call flow that depicts an example conventional information flow for an authentication;

FIG. 4 is a call flow that illustrates an information flow for an authentication in accordance with another example embodiment in which an attack surface is reduced as compared to the attack surface of the information flow depicted by FIG. 3;

FIG. 5 is a system diagram that shows example entities for protecting data in accordance with an example embodiment;

FIG. 6 is a flow diagram of an example method that can be performed by the system depicted in FIG. 5 according to an example embodiment;

FIG. 7 is a system diagram of an example virtual machine (VM) hosting platform in which one or more disclosed embodiments may be implemented;

FIG. 8 shows an example VM hosting platform memory architecture;

FIG. 9A is a system diagram of an example communications system in which one or more disclosed embodiments may be implemented;

FIG. 9B is a system diagram of an example wireless transmit/receive unit (WTRU) that may be used within the communications system illustrated in FIG. 9A; and

FIG. 9C is a system diagram of an example radio access network and an example core network that may be used within the communications system illustrated in FIG. 9A.

### DETAILED DESCRIPTION OF ILLUSTRATIVE EMBODIMENTS

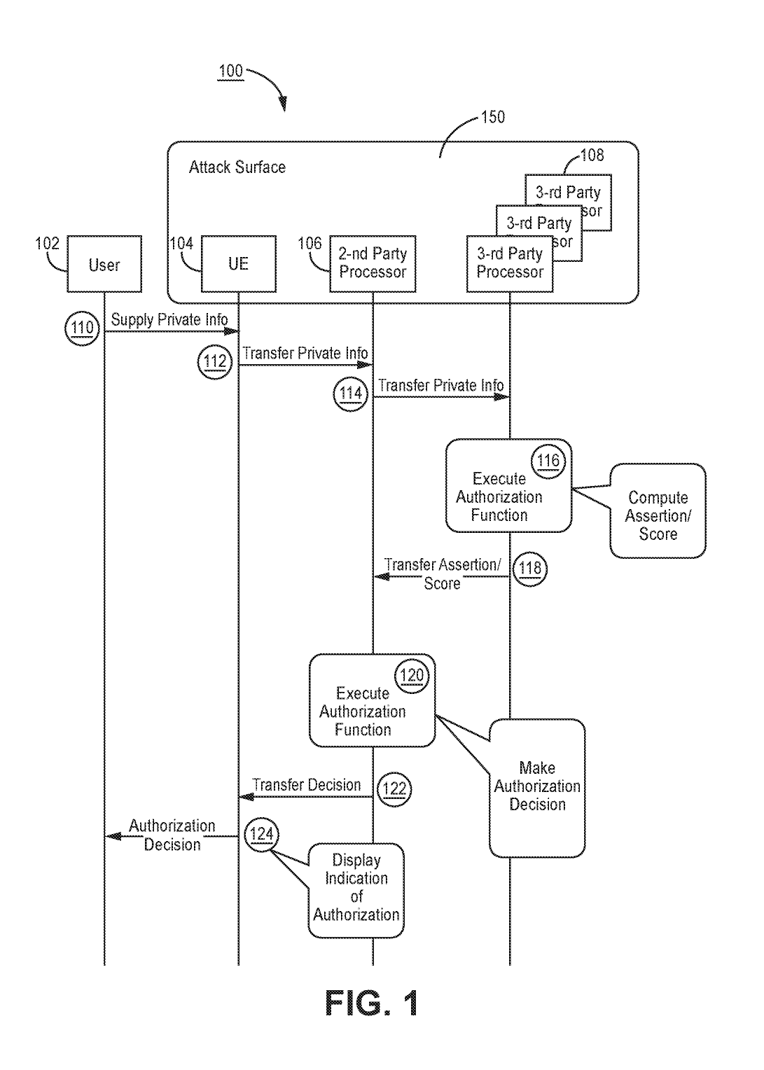

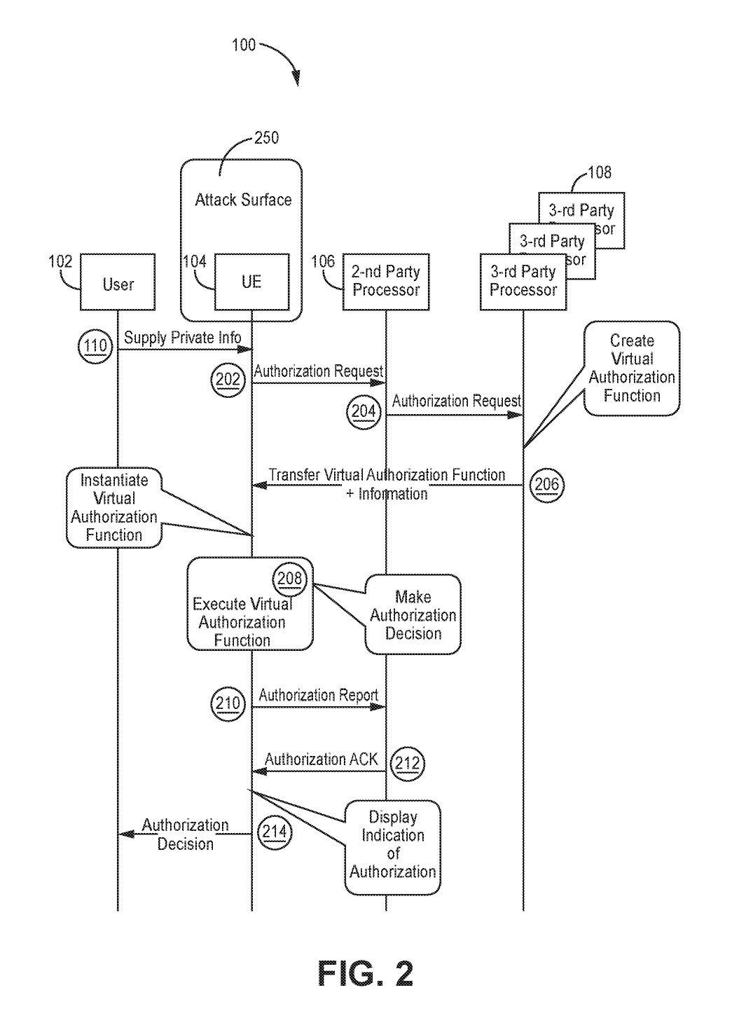

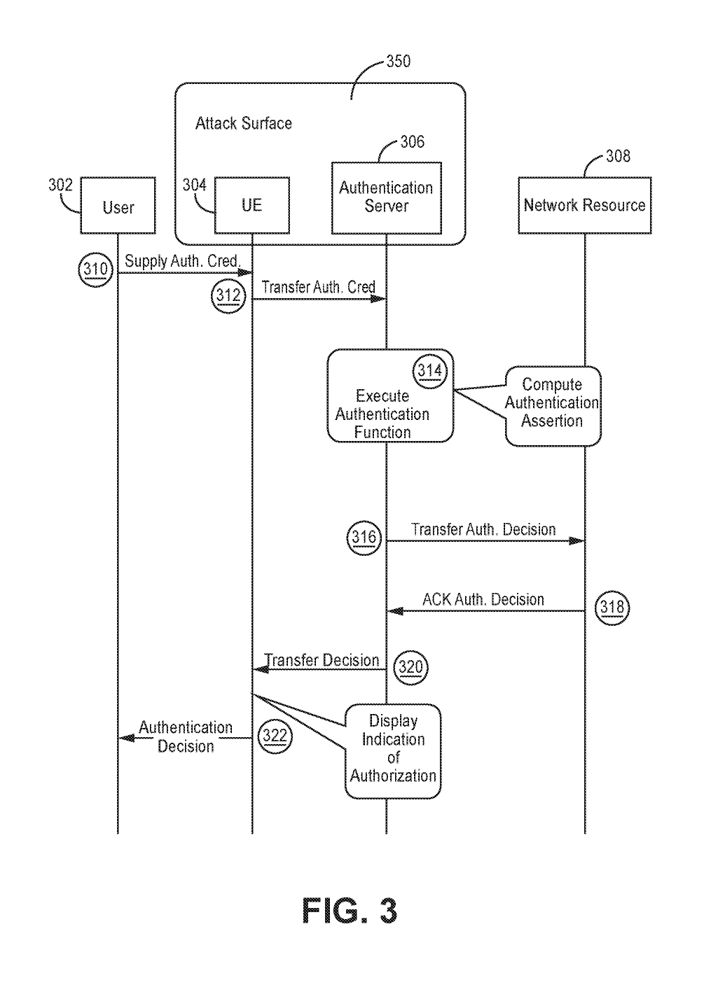

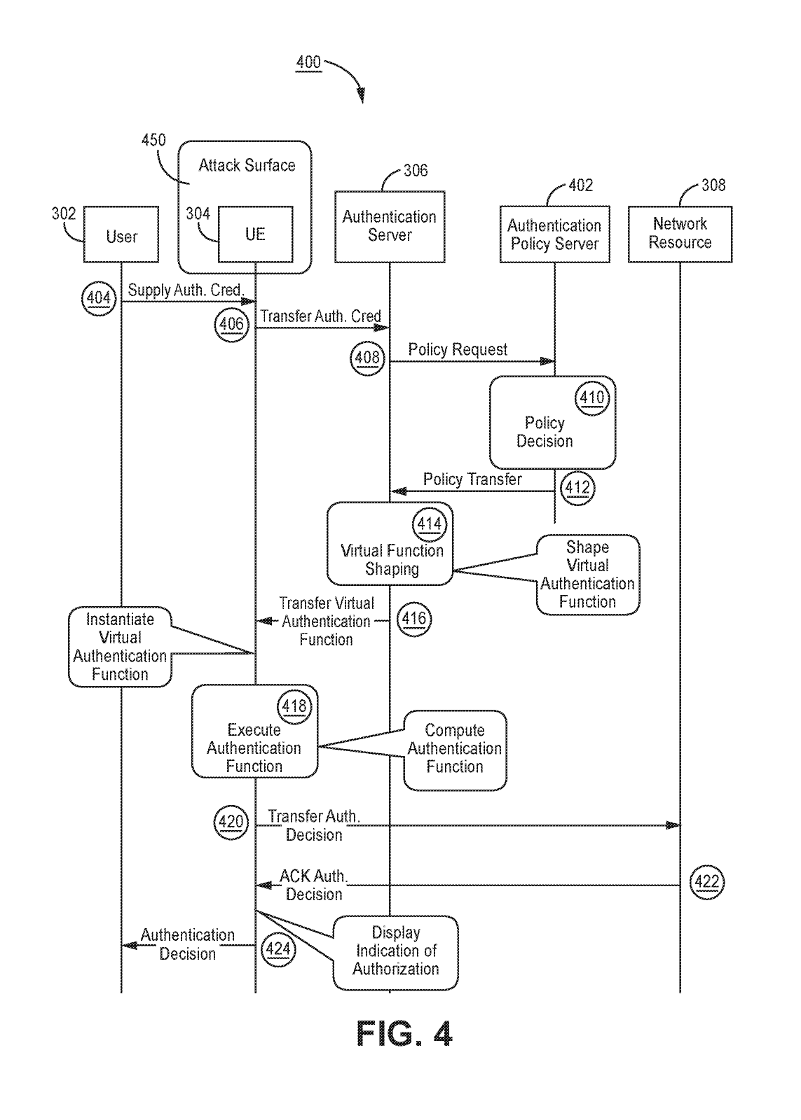

FIGS. 1 and 2 illustrate a first example use case, and FIGS. 3 and 4 illustrate a second example use case. The use cases illustrate how the proposed data protection mechanisms, combined with virtualization and platform integrity techniques, may minimize the loss of privacy/confidentiality during various secure and trustworthy operations conducted by a third party that consumes data. It will be understood that the use cases are presented for purposes of example, and the concepts disclosed herein can be applied to other use cases as desired.

Referring initially to FIGS. 1 and 2, the first use case depicts a retailer that wants to establish the creditworthiness of a consumer, which is represented as user 102. As shown in FIGS. 1 and 2, a system or network 100 includes the user 102, a user equipment 104, a second party data processor 106, a plurality of third party data processors 108. It will be appreciated that the example network 100 is simplified to facilitate description of the disclosed subject matter and is not intended to limit the scope of this disclosure. Other devices, systems, and configurations may be used to implement the embodiments disclosed herein in addition to, or instead of, a network such as the network 100, and all such embodiments are contemplated as within the scope of the present disclosure.

With continuing reference to FIGS. 1 and 2, as shown, the retailer performs a check of creditworthiness of the consumer with a credit rating agency. The specific retailer in this example is a Mobile Network Operator (MNO) that wishes to check the creditworthiness of a consumer prior to establishing a postpaid mobile subscription for the consumer. In this use case, private information of the user 102, who is an applicant for the postpaid subscription, is being collected at the UE 104 (at 110). In this example, the UE 104 may be considered an endpoint computing device, and the UE 104 may be a mobile phone, a personal computer, an MNO kiosk, or the like.

Referring in particular to FIG. 1, at 112, the private information is forwarded to the second party processor 106, which may be an MNO for example. At 114, the private information is forwarded to a third party processor 108, which may be part of a credit reporting agency for example. It will be understood that the private information may include any data or information associated with the user 102 or the UE 104. It may also be the case that the private user information is obtained from other third parties, such as the user's mortgage company, utilities companies, or the like, and provided to the third party processor 108. At 116, the information is processed. In accordance with the example, the processing may include generating an authorization assertion or generating a weighted authorization score (e.g., FICO credit report). In the illustrated example, the nature of the private information requires that information be removed (deleted) following consumption and upon production of the credit worthiness assertions. In some cases, however, such a policy is practically unenforceable from the user's point of view. It is recognized herein that accumulation of a user's private information at either the MNO (second party 104) or third party processors 108 creates an attraction for unlawful access to such information, from either inside or outside adversaries, for example during the time of consumption or when the personal data is stored at these entities.

Still referring to FIG. 1, in accordance with the illustrated example, at 116, the third party data processor 108 (e.g., Credit Rating Agency) executes an authorization function (e.g., computes credit score or assertion of authorization) to determine a computational result. At 118, the third party data processor (e.g., Credit Rating Agency) transfers the computational result to the second party data processor 106 (e.g., MNO) for an authorization decision. At 120, the second party data processor 106 (e.g., MNO) executes the authorization function to compute the authorization decision. At 122, the second party data processor (e.g., MNO) forwards the authorization decision to the UE 104 for display to the user 102. At 124, the authorization decision is communicated to the user 102.

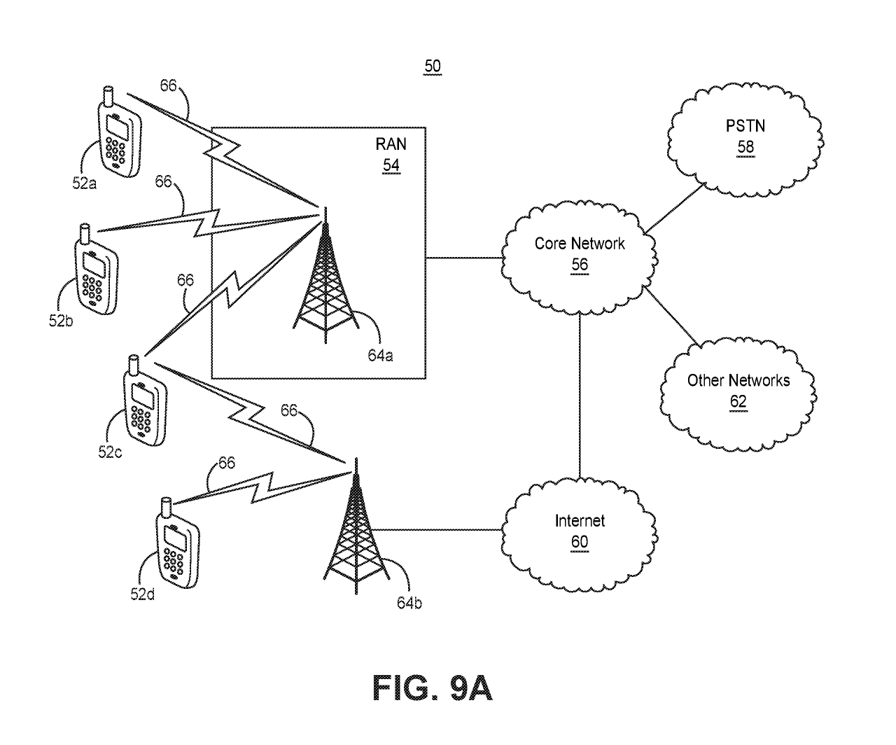

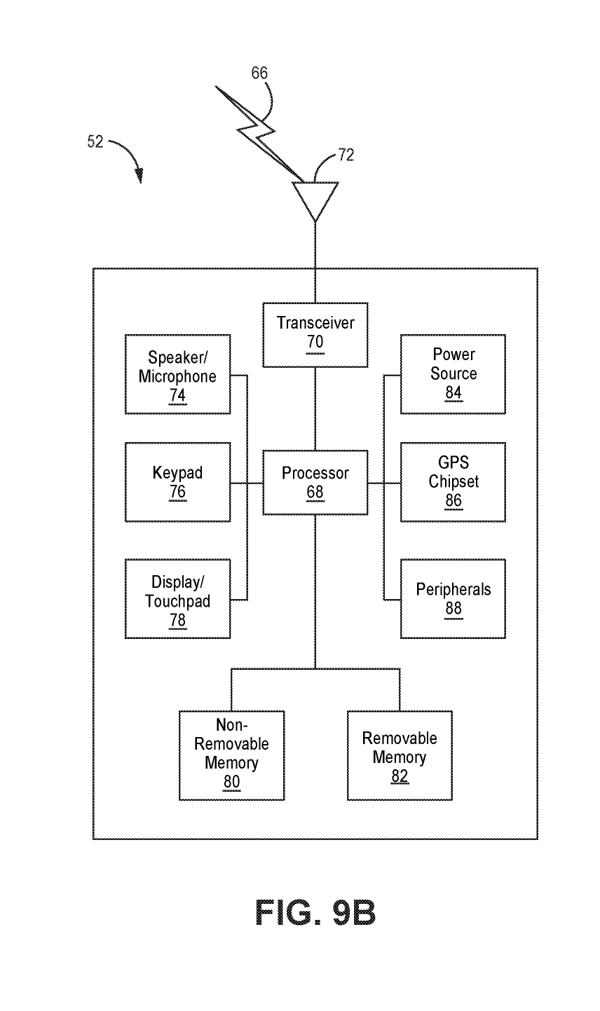

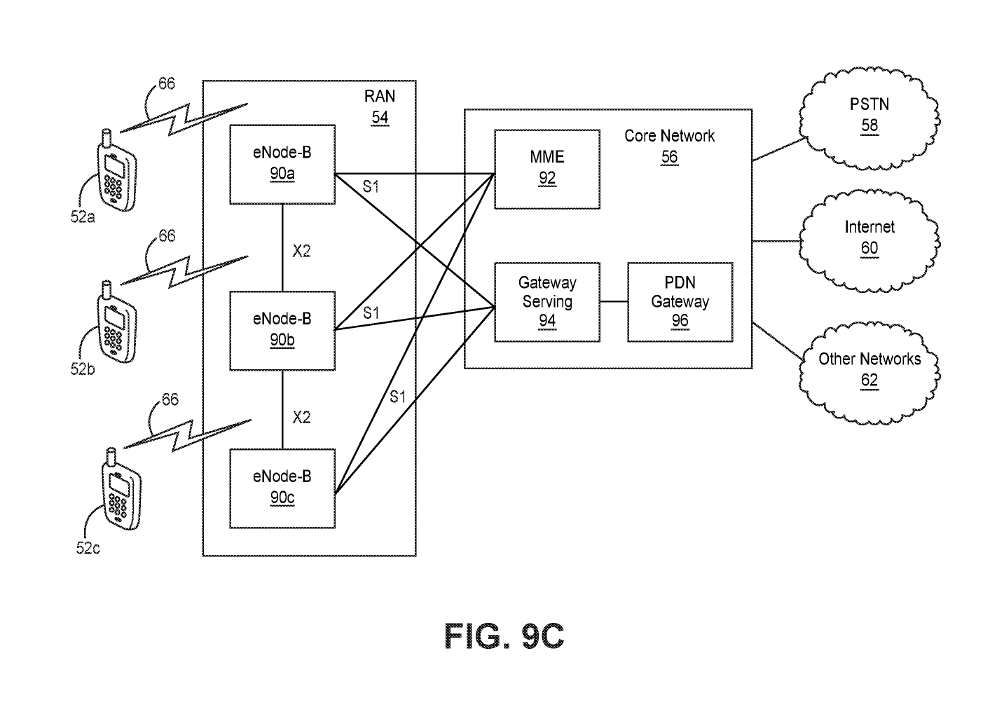

FIGS. 2 and 4-7 (described hereinafter) illustrate various embodiments of methods and apparatuses for protecting data or information. As used herein, unless otherwise specified, the terms data and information may be used interchangeably, without limitation. In these figures, various steps or operations are shown being performed by one or more nodes, apparatuses, devices, functions, or networks. For example, the apparatuses may operate singly or in combination with each other to effect the methods described herein. As used herein, the terms apparatus, network apparatus, node, device, entity, network function, and network node may be used interchangeably. It is understood that the nodes, devices, functions, or networks illustrated in these figures may represent logical entities in a communication network and may be implemented in the form of software (e.g., computer-executable instructions) stored in a memory of, and executing on a processor of, a node of such network, which may comprise one of the general architectures described herein. That is, the methods illustrated herein may be implemented in the form of software (e.g., computer-executable instructions) stored in a memory of a network node, such as for example the node in FIG. 9B, which computer executable instructions, when executed by a processor of the node, perform the steps illustrated in the figures.

Referring now to FIG. 2, FIG. 2 shows the example system 100 for protecting information (data) in accordance with an example embodiment. In accordance with the illustrated example, at 110, the user 102 inputs his/her private/confidential information into the UE 104. At 202, the UE 104 stores the private/confidential information locally in protected memory and forwards an authorization request to the second party data processor 106 (e.g., MNO). At 204, in accordance with the illustrated embodiment, the second party data processor 106 (e.g., MNO) forwards the authorization request to the third party data processor 108 (e.g., Credit Rating Agency). At 206, the third party data processor 108 (e.g., Credit Rating Agency) creates a virtual authorization function and transfers it to the UE 102 for instantiation. The virtual authorization function may comprises a Java Applet, a remote procedure call (RPC), a virtual network function (VNF), or any remotely executed function of sufficient portability and security.

Still referring to FIG. 2, at 208, in accordance with the example embodiment, the UE 102 verifies the integrity and authenticity of the received virtual authorization function, verifies authorization, and instantiates and executes (e.g., computes Credit Score or assertion of authorization) the virtual authorization function in its protected execution environment using the user's private/confidential information that the UE 104 received at 102, thereby computing the authorization decision. In some cases, one or more of the third parties 108 may have previously interacted with the user 102 and stored some of the user's personal information, or processed information at the user's UE 104 for later consumption. For example, personal user credit history data may be collected over a period of time. The integrity and authenticity of the received virtual authorization function can be verified by the UE 104 implementing one or more industry standard methods (e.g., signed hash of the code, pre-provisioned vendor certificate, etc.). At 210, in accordance with the illustrated embodiment, the UE 104 transfers the computational result (e.g., credit score or assertion of authorization) determined at 208 to the second party data processor 106 (e.g., MNO). At 212, the second party data processor 106 sends an acknowledgment to the UE 104 that it received the computational result (e.g., credit score or assertion of authorization). At 214, the authorization decision (e.g., whether the user is authorized) is communicated to the user 102. Thus, an attack surface 250 includes the UE 104 in accordance with the example depicted in FIG. 2, and an attack surface 150 includes the UE 104, the second party data processor 106, and one or more third party data processors 108 in accordance with the example depicted in FIG. 1. Therefore, the attack surface 250 is reduced as compared to the attack surface 150.

Referring now to FIGS. 3 and 4, the second example use case depicts an authentication of a network entity for admission to a network, using a network entity identity and network entity credentials. In particular, the use case depicted in FIGS. 3 and 4 demonstrates authentication of a UE 302 to a network resource 308. The example information flow depicted in FIG. 4 demonstrates shrinkage of the attack surface 450 as compared to the attack surface 350 of a conventional flow illustrated in FIG. 3. In the conventional information flow of FIG. 3, the user's credentials are propagated all the way to an authentication server 306. In the information flow depicted by FIG. 4, however, the user's credentials do not leave the trusted perimeter of the user's UE 302. The second uses case also illustrates a policy-driven selection of a virtual authentication function in accordance with an example embodiment (e.g., based on a heuristic algorithm or a set of predefined parameters such as time of day, location, etc.).

Referring in particular to FIG. 3, at 310, the user 302 inputs identity and authentication credential(s) into the UE 304. At 312, the UE 304 forwards the identity and authentication credential(s) (or their hash) to the authentication server 306. At 314, the authentication server 306 executes an authentication function. For example, the authentication server 306 may compare a supplied set of credentials or its hash for the given identity to the set of credentials or its hash stored at the authentication server 306. The authentication server 306, in accordance with the illustrated example, executes the function to compute an authentication assertion. At 316, the authentication server 306 transfers the authentication assertion to the network resource 308. At 318, the network resource 308 acknowledges to the authentication server 306 the receipt of the authentication assertion. At 320, the authentication server forwards an authentication decision to the UE 304 for display. At 322, the authentication decision is communicated to the user 302.

Referring now to FIG. 4, which shows an example system or network 400 for protecting authentication information in accordance with an example embodiment. The network 400 includes the UE 304 having the user 302, the authentication server 306, the network resource 308, and an authentication policy server 402. It will be appreciated that the example system 400 illustrated in FIG. 4 is simplified to facilitate description of the disclosed subject matter and is not intended to limit the scope of this disclosure. Other devices, systems, and configurations may be used to implement the embodiments disclosed herein in addition to, or instead of, a system such as the illustrated system 400, and all such embodiments are contemplated as within the scope of the present disclosure.

At 404, in accordance with the illustrated example, the user 302 inputs an identity and one or more authentication credentials into the UE 302. At 406, the UE 304 forwards the identity and the one or more authentication credentials (or their hash) to the authentication server 306. At 408, the authentication server 306 creates a policy request. For example, the authentication server 306 may request a particular authentication policy for a particular user identity. The policy request is sent to the authentication policy server 402. At 410, in accordance with the illustrated example, the authentication policy server 402 computes the appropriate authentication policy executing the authentication function (e.g., by comparing a supplied set of credentials or its hash for the given identity to the set of credentials or its hash stored at the Authentication Server). At 412, the authentication policy server 402 transfers the authentication policy to the authentication server 306. At 414, in accordance with the illustrated example, the authentication server 306 creates or selects a virtual authentication function based on the authentication policy received at 412. The virtual authentication function may be generated or selected by a virtual function shaping. A virtual function shaping in this example may perform multi-factor authentication. The characteristics of the user device, with respect to performing user authentication and the various factors of authentication available on the user device (e.g., fingerprint reading, facial recognition, retina scanning, etc.), may be tailored to the specific user and user device. Thus, virtual shaping may refer to the customization or tailoring of the authentication based on a number of criteria and policies, such as, for example, the previously conducted authentications and the results, the data or service being sought, the factors of authentication available, or the like. For example, the authentication server 306 may select from virtual authentication functions that are available to the UE 302. Alternatively, the authentication server 306 may create the virtual authentication function that is shaped. In an example, the virtual authentication function may be shaped to be suitable for a specific location in which the function will be executed. For example, a virtual authentication function may be shaped to satisfy the capabilities of the UE 302 and the authentication policy. In some cases, by way of further example, virtual function shaping may relate to fingerprints, such that the virtual authentication function might not ask for the user's fingerprint if the UE 302 is not equipped with, or cannot furnish, a trusted fingerprint reader. Instead of the fingerprint, for example, the virtual authentication function may ask for and process two authentication factors and the location of the UE 302.

Still referring to FIG. 4, at 416, in accordance with the illustrated embodiment, the authentication server 306 forwards the virtual authentication function to the UE 302 for execution on behalf of the authentication server 306. At 418, the UE 302 verifies the integrity and authenticity of the received virtual authentication function, instantiates and executes it on behalf of the authentication server 306, and computes an authentication assertion (the authentication decision). In some cases, the integrity and authenticity of the received virtual authentication function can be verified by implementing one or more industry standard methods (e.g., signed hash of the code, pre-provisioned vendor certificate, etc.). At 420, as shown, the UE 304 may forward the authentication assertion (e.g., the Authentication Decision) to the network resource 308. At 422, in accordance with the illustrated example, the network resource 308 acknowledges to the UE 304 the receipt of the authentication assertion. At 424, the authentication decision may be communicated to the user 302.

As shown in the above-described uses cases, confidential and private information related to a transaction may be circulated from more than one party, and sometimes through several intermediaries, for consumption. As shown by the example embodiments depicted by FIGS. 2 and 4, the circulation of information may be minimized by instead circulating one or more processing functions to an information holding entity for processing. Thus, the processing and the generation of appropriate authorization assertions or results may be carried out in a manner in which the information required for processing does not leave a central holding entity. In some cases, the central holding entity may be the owner or controller of the data, and thus the data may be on the user device or hosted at a trusted third party. In some cases, the exposure of the information is minimized by not distributing the information. Instead, the information may be centrally located and controlled such that the information is available to select authorized processes on a need to know basis, directly or indirectly.

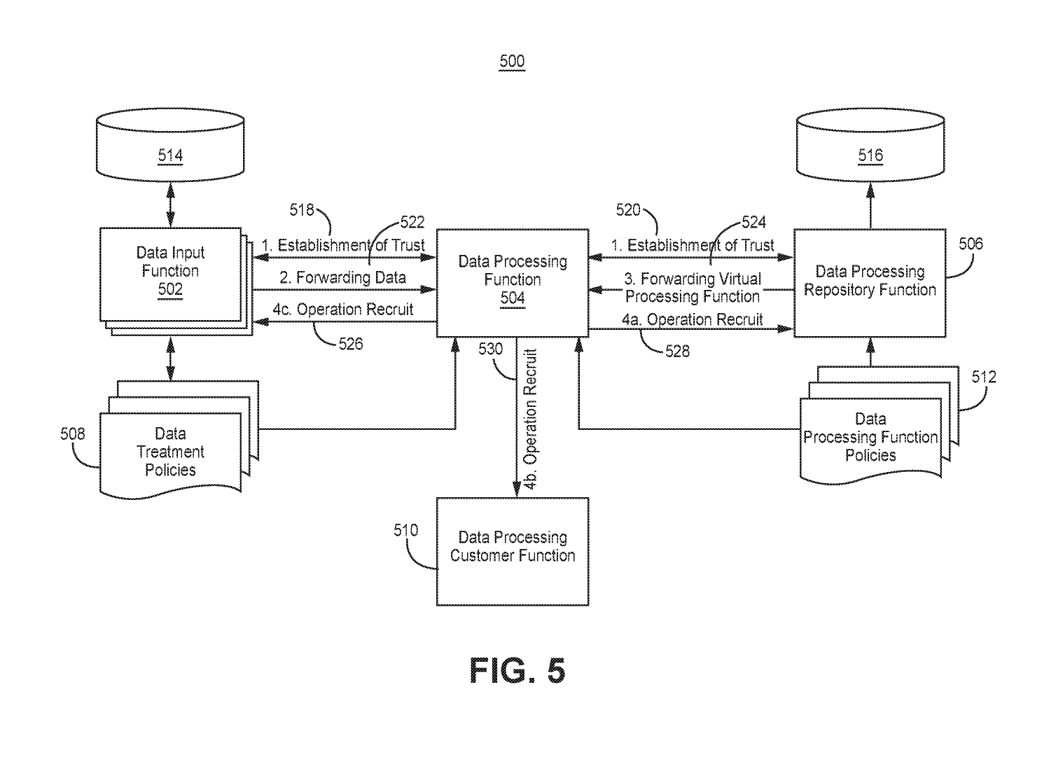

Turning now to FIG. 5, an example system 500 is depicted in accordance with an example embodiment. As shown in FIG. 5, the system 500 includes one or more data input functions 502, one or more data processing functions 504, one or more data processing repository functions 506, and one or more data processing customer functions 510. It will be appreciated that the example system 500 is simplified to facilitate description of the disclosed subject matter and is not intended to limit the scope of this disclosure. Other devices, systems, and configurations may be used to implement the embodiments disclosed herein in addition to, or instead of, a system such as the system 500, and all such embodiments are contemplated as within the scope of the present disclosure.

As shown, in accordance with the illustrated example, at 518, the data input function (DIF) 502 establishes trust with the data processing function (DPF) 504. At 520, the data processing repository function (DPRF) 506 establishes trust with the DPF 504. During this step, appropriate data treatment policies (DTP) 508 and data processing function policies (DPFP) 512 may be determined. At 522, using the DTP 508, for example, the DIF 502 may securely forwards its data to the DPF 504. In an example, the DPF 504 is a functional entity designated to perform the processing functions on data. For example, the DPF 504 may be contained in a UE or a network node. At 524, in accordance with the illustrated example, using the DPFP 512, for example, the DPRF 506 may securely forward one or more virtual processing functions (VPFs) to the DPF 504 to perform data processing functions on data from the DIF 502. In some cases, the DPF 504 may be located at any place in the network. For example, the DPF 504 may be located at secure nodes for processing data. The DPF 504 may perform each of the processing functions on respective portions of data. Thus, the DPF 504 may determine or generate a result, for instance a data processing result, based on the processing functions. The data processing results may be forwarded to one or more of the DIF 502 (at 526), the DPRF 506 (at 528), and/or the data processing customer function (DPCF) 510 (at 530).

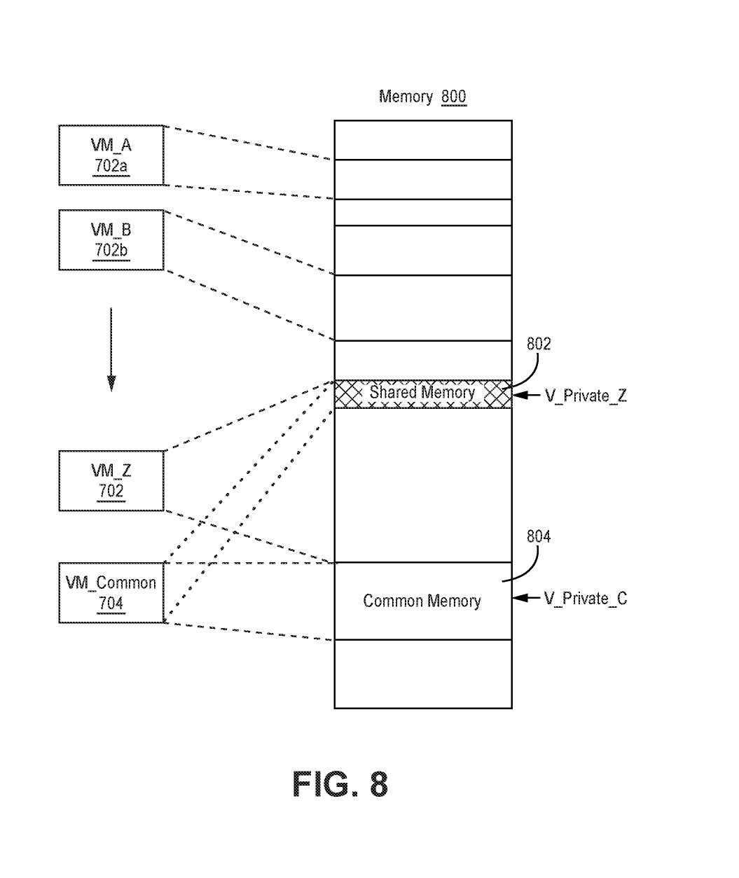

Still referring generally to FIG. 5, the data processing customer function, which may be referred to generally as a network entity, may send a request to a node for a result that requires at least one of the processing functions 504 to be performed on data. The data may be stored on a data node, such as a memory 514 or memory 818 (see FIG. 8) for example. Thus, the node may receive a request, from a network entity, for a result that requires at least one processing function to be performed on data, wherein at least some of the data is stored on a data node. The data that is stored on the data node may be controlled by a plurality of control nodes, such that each control node controls a respective portion of the data. The node may receive a respective processing function from each of the plurality of control nodes, and each processing function may be associated with a respective control node. For example, each control node may control a portion of memory 516 in which its respective processing functions are stored. The node may perform each of the processing functions on the respective portion of data that is controlled by the control node associated with the processing function. The node may further determine a result based on the processing functions, and sending the result to the network entity (e.g., data processing customer function 510), for instance without transferring any of the data used to determine the result. The node may further receive user data from a user of the node, such that at least one of the processing functions is also performed on the user data. In one example, the node retrieves the data directly stored on the data node (e.g., memory 514) directly from the data node. In another example, the node includes the data node (e.g., memory 514).

In some cases, the virtual processing functions may be evaluated and certified (e.g., using Common Criteria, commercial product assurance (CPA), or the like) to ensure that the private information is not compromised and that only legitimate functions are performed on private data. In an example, to prevent private data compromise, the certificate of evaluation for the virtual processing function, which may be cryptographically bound to the virtual processing function code, may be analyzed prior to accepting and executing the virtual processing function in a central location. The private data may also be encrypted with the owner's credentials so as to protect the data in storage. Further, the data may be encrypted so that the data is exposed only to authorized processing functions. The processing functions may be authorized by the owner of the data, and the authorization may be verified by the node. For example, in the case of personal user data, each individual user's data may be encrypted with the user's credentials, thereby reducing the attack surface on data held in a central location. In some cases, the user's authorization credentials may be obtained during the time of a transaction, and those credentials may be securely disposed of, based on enforced policy for example, after the processing has been completed. Thus, in an example use case, an attacker would have to obtain the user's credentials, for instance all of the user's credentials, in order to gain access to the centrally held private data.

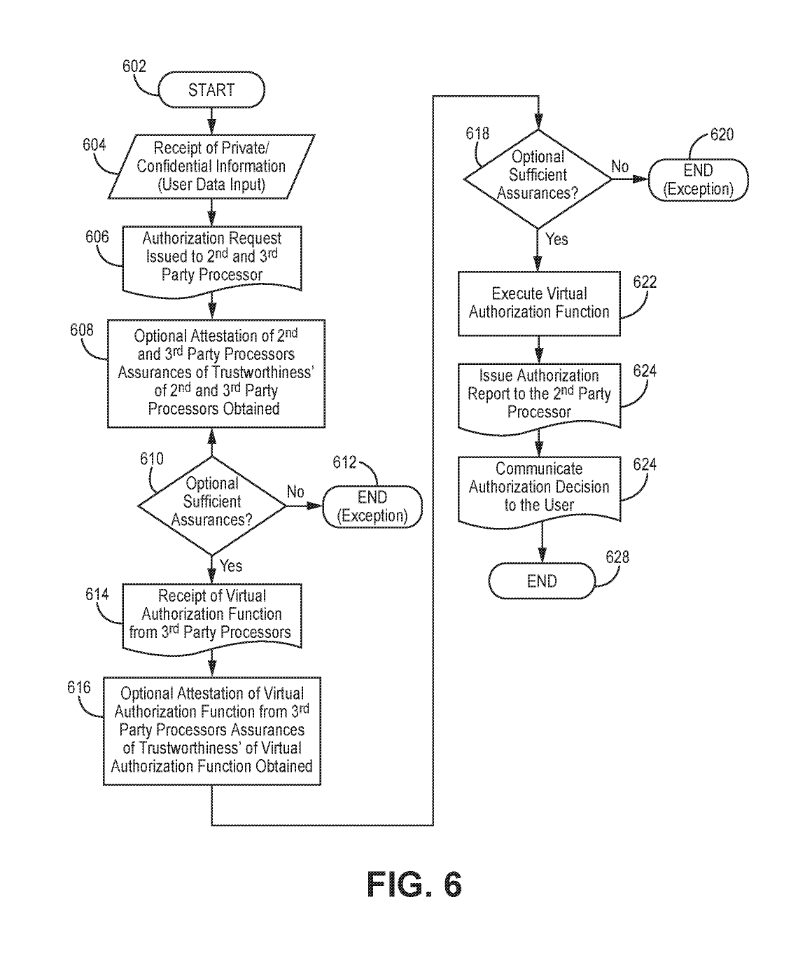

Referring again to the example depicted in FIG. 2, a credit rating agency may have access to massive amounts of user information. For example, the information may be associated with many, for instance millions, of user records. This information may be held in one entity, for instance the credit rating agency, and thus valuable user data could become vulnerable to a single point of attack. Alternatively, as shown in the example depicted in FIG. 2, information/data for each user might instead be held in the user's own UE device, thereby distributing the data and reducing the possibility of an attacker being able to gather massive amounts of user data by attacking a single entity. With reference to FIG. 6, further detail is provided concerning the processing on the UE 102 illustrated in FIG. 2.

At 602, the example process begins. At 604, the DIF 502 may receive user input or collect user data. For example, in accordance with one example, the user wishes to obtain credit or a loan for a purchase and seeks to apply for the credit via his/her UE. Thus, at 606, the UE issues an authorization request to a supplier, which may be the second party processor. The supplier may then seek the user's credit score by extending the request to a credit rating agency and other stakeholders who can provide information associated with the user to determine the user's credit score. The credit rating agency and other stakeholders may be referred to as third party processors. At 608, in accordance with the illustrated example, the DIF 502, which may be on the UE 104, may obtain assurances of trustworthiness of the second and third party processors 106 and 108, respectively. In some cases, assurances of trustworthiness may be obtained by implementing one or more industry standards (e.g., attestation using TNC from TCG, certification verification, business evaluation, reputation assessment, etc.). At 610, the DIF 502 compares the assurances obtained at 608 with its policy. Based on the comparison, the process may proceed to 612 or 614. If the comparison results in an unsuccessful check, the process may proceed to 612, wherein exceptions are handled. Exceptions may be handled in a variety of ways, such as, for example, by logging the exception in an activity log, sending a verification failure message to various network entities for further action, requesting further information from the source node to gain an acceptable level of assurance, or the like. As used herein, unless otherwise stated, exceptions may be detected and handled in accordance with pre-defined or derived policies for error or exception handling. If the comparison is successful and there are sufficient assurances, the process may proceed to 614, wherein the DIF 502, which may be on the UE 104, receives virtual authorization functions from the third party processors 108 (e.g., the Credit Rating Agency, a credit card company, a mortgage holder, a utility company, etc.). The information of interest for these individual third parties may comprise but is not limited to loan amounts, loan amount outstanding, term of any loans, loan repayment history, income, utility bill payments, punctuality of payments, etc. Such information may be included as input parameters to the virtual authorization functions, which may be carried out at the UE 104 in the Data Processing Function 504. The virtual authorization functions may comprise a Java Applet, a Remote Procedure Call (RPC), a Virtual Network Function (VNF), or any remotely executed function of sufficient portability and security.

Still referring in particular to FIG. 6, at 616, prior to the delivery, the third party data processors 108 may gain assurances about the trustworthiness of the execution environment for the virtual authorization functions on the UE 104. For example, the third party processors 108 may gain assurances by initiating an attestation of the UE 104. In some cases, the DIF 502 on the UE 104 may in turn obtain assurances of trustworthiness for the third party data processors 108 that provide the virtual authorization functions received at 614. In some cases, virtual authorization functions may be verified by implementing one or more industry standard methods (e.g., code signing and verifying a signed hash of the code, verifying a pre-provisioned vendor certificate, verifying the results of various evaluation criteria, verifying a signed certificate of security assurance/evaluation, etc.). At 618, the DIF 502 and the DPF 504, which are on the UE 104 in accordance with one example, may compare the assurances obtained at 616 with its policy. If the comparison is unsuccessful and the assurances are not sufficient, the process may proceed to 620, where exceptions are handled. If the comparison is successful and the assurances are sufficient, the process may proceed to 622, wherein the DPF 504, and thus the UE 104 in accordance with the example depicted in FIG. 2, executes the virtual authorization functions received at 614.

In one example, the DPF 504 on the UE 104 produces a credit score or data related to enable determination of the credit score, and delivers the result to a credit rating agency, which may be one of the third party processors 108, at 624. In some cases, the credit rating agency determines the credit score and returns it to the supplier, which may be the second party processor 106. Alternatively, as shown in FIG. 2, the credit rating agency may provide a virtual authorization function for the final decision and credit score to be determined at the DPF 504 on the UE 104 and delivered directly to the supplier. At 626, the final decision based on the credit score is delivered to the user and the credit/loan is granted or denied. The example process ends at 628.

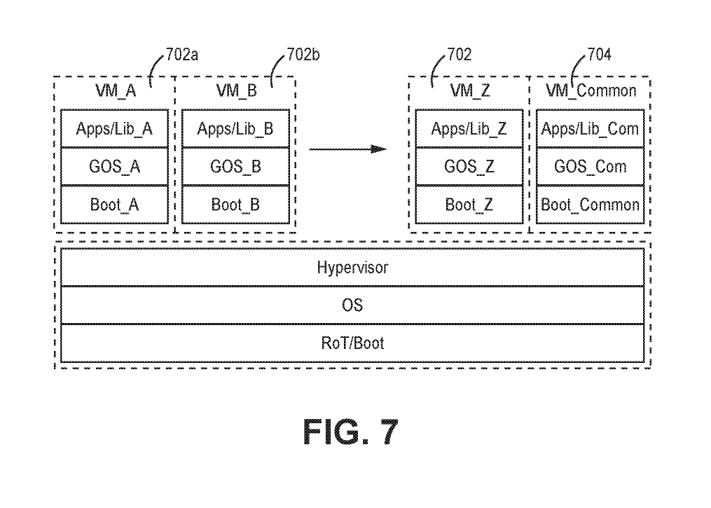

In accordance with an example embodiment, private information is processed using virtualization and policy driven techniques, such that the secure storage of information is ensured and secure processing by functions that consume the information is ensured. Referring now to FIG. 7, an example cloud service function is shown that hosts multiple parties, each with their own data storage space and processing functions that are isolated from the host platform and each other. The isolation may be accomplished by using, for example, secure virtualization or containerization technologies that are anchored on a trusted computing platform architecture.

As shown, the processing and data held in each virtual machine 702 is isolated from other virtual machines 702 and the host platform itself. For example, a first virtual machine 702a may store data and processing functions that are isolated from a second virtual machine 702b that may store data and processing functions. The security and assurances of such an architecture may achieve the security described herein.

In some cases, as shown, there is a common virtual machine (VM) 704 that has its own processing and storage capabilities. The common VM may 704 communicate with other virtual machines 702, such as the first and second virtual machines 702a and 702b, through secure channels. The common VM 704 may host the private data that the other VM tenants may wish to consume or process.

Referring also to FIG. 8, a view of the platform from the perspective of a memory map for programs and data is shown. In accordance with the example, each VM 702 has its own computational capabilities and portion of memory 800 that is isolated from other VMs and the host. Policies may allow a part of the memory of a particular VM to be shared with the common VM 704 so as to define a shared memory 802. Further, a given VM 702 may provision or deploy a processing function into the common VM 704 to execute on the data held by the common VM 704 in the common memory 804. Thus, a configuration may be achieved whereby private data may be held by a given VM 702, the common VM 704, or both. Similarly, processing functions may be deployed on a given VM 702, the common VM 704, or both. Through various configurations, the security of the data may be maintained centrally, without leaving the platform, in order to perform computational functions on the private data, on behalf of more than one VM party.

FIG. 8 shows a capability for a given VM 702 (depicted also as VM_Z) to furnish the common VM 704 with a processing function to execute on the private data (V Private C) held by the common VM 704 in the common memory 804. In an example, only the common VM 704 has direct access to this private data, and the given VM 702 (VM_Z) has indirect access for the purpose of performing a function on (or processing) the private data. Optionally, through appropriate policies of the owner of the private data and/or the given VM 702 (VM_Z), the common VM 704 may have access to the private data (V_{—} Private_Z) held by VM_Z in its shared memory 802. In yet another embodiment, the common VM 704 may have indirect access to the private data (V_{—} Private_Z) held by VM_Z by providing processing functions to VM_Z to be performed on the data.

In an example, the processing functions (e.g., virtual authorization functions) discussed herein may be evaluated and certified to ensure that the private information is not compromised, and to ensure that only legitimate functions are performed on the private data. The private data may also be encrypted with the owner's credentials so as to protect the data in storage, and to only enable the data to be exposed to authorized processing functions. The private data may also be encrypted with the owner's credentials so that the data is only exposed under the authority of the owner of the data. In the case of personal user data, for example, each individual user's data may be encrypted with the user's credentials, thereby reducing the attack vector on the data held in the central location. The user's authorization credentials may be obtained during the time of a transaction and securely disposed after the processing has been completed. In some cases, an attacker has to obtain all of the user's credentials in order to gain access to the centrally held private data.

Referring again to FIG. 6, an example of the processing of a credit score in the cloud server architecture described above is now discussed. At 604, the DIF 502, which may be in a cloud server or network node, may receive user input or collect user data. This data may come from third party processors (e.g., a credit card company, a mortgage holder, a utility company etc.). These parties may be hosted in virtual environments, such as in one or more of the virtual machines 702. In accordance with one example, the user wishes to obtain credit or a loan for a purchase and seeks to apply for the credit via his/her UE. Thus, at 606, the UE issues an authorization request to a supplier, which may be the second party processor. The supplier may then seek the user's credit score by extending the request to a credit rating agency and other stakeholders who can provide information associated with the user to determine the user's credit score. The credit rating agency and other stakeholders may be referred to as third party processors. At 608, in accordance with the illustrated example, the DIF 502, which may be on the cloud server, may obtain assurances of trustworthiness of the second and third party processors. It will be understood that cloud server and network node may be used interchangeable herein, without limitation. In some cases, assurances of trustworthiness may be obtained by implementing one or more industry standards (e.g., attestation using TNC from TCG, certification verification, business evaluation, reputation assessment, etc.). At 610, the DIF 502 compares the assurances obtained at 608 with its policy. Based on the comparison, the process may proceed to 612 or 614. If the comparison results in an unsuccessful check, the process may proceed to 612, wherein exceptions are handled. If the comparison is successful and there are sufficient assurances, the process may proceed to 614, wherein the DIF 502, which may be on the network node, receives virtual authorization functions from the third party processors 108 (e.g., the Credit Rating Agency, a credit card company, a mortgage holder, a utility company, etc.). The information of interest for these individual third parties may comprise but is not limited to loan amounts, loan amount outstanding, term of any loans, loan repayment history, income, utility bill payments, punctuality of payments, etc. This data may be held securely on behalf of these third parties at the DIF 502 in the cloud. Such information may be included as input parameters to the Virtual Authorization Function(s), which are carried out in the DPF 504 in the cloud. The virtual authorization functions may comprise a Java Applet, Remote Procedure Call (RPC), a Virtual Network Function (VNF), or any function which may be executed in the cloud server, of sufficient portability and security. As an example, data for a credit card company may be held in a given VM 702 (e.g., VM_Z) in its private portion of memory 800 or its shared memory 802.

Still referring in particular to FIG. 6, at 616, prior to the delivery, the third party data processors may gain assurances about the trustworthiness of the execution environment for the virtual authorization functions on the cloud server. For example, the third party processors may gain assurances by initiating attestation of the cloud server. In some cases, the DIF 502 on the cloud server may in turn obtain assurances of trustworthiness for the third party data processors 108 that provide the virtual authorization functions received at 614. In some cases, virtual authorization functions may be verified by implementing one or more industry standard methods (e.g., a signed hash of the code, pre-provisioned vendor certificate, evaluation criteria, etc.). At 618, the DIF 502 and the DPF 504, which are on the cloud server in accordance with one example, may compare the assurances obtained at 616 with its policy. If the comparison is unsuccessful and the assurances are not sufficient, the process may proceed to 620, where exceptions are handled. If the comparison is successful and the assurances are sufficient, the process may proceed to 622, wherein the DPF 504, and thus the cloud server in accordance with the example, executes the virtual authorization functions received at 614.

In one example, at 622, a credit rating agency hosted by the common VM 704 hosts the data processing functions in the cloud server and executes the functions received at 614. By way of example, the virtual authorization functions for a credit card company may be provided over a secure channel between the credit card company hosted by a given VM 702 (e.g., VM_Z) and the credit rating agency hosted by the common VM 704. In an alternative embodiment, the credit card company hosted by a given VM 702 (e.g., VM_Z) may allow the credit rating agency hosted by the common VM 704 access to its shared memory 802, to perform the appropriate processing from within the common VM 704. In yet another alternative embodiment, the credit card company hosted by a given VM 702 (e.g., VM_Z) may execute appropriate processing functions provided by the credit rating agency on VM 702. Similarly, the processing functions for other third party processors, whose data is hosted in the cloud server, can be carried out in a secure and trustworthy manner. The processing functions may be carried out sequentially, concurrently, or in an integrated or interlaced manner to achieve an overall processing function in which input data is processed and an output may be processed. In some cases, the memories that comprise the memory 800 are sanitized and erased of the data after intermediate processing or after the final processing is complete, thereby achieving an objective of minimizing the vector of attack on private data by allowing indirect, restricted, and/or controlled access to the data. At 624, in accordance with the example, the data processing functions 504 of the credit rating agency that is hosted on the cloud server determines the credit score and returns it to the supplier, which may be the second party processor 106. At 626, the final decision based on the credit score is delivered to the user and the credit/loan is granted or denied. The example process ends at 628. It will be understood that the credit score computation is used merely for purposes of example, and the methods described herein may be used to process any data for any result as desired.

In another embodiment, the processing functions that are owned and controlled by second or third party entities wishing to perform functions on private data may be cached. This may enable easier access and more efficient instantiation of the functions, closer to the point of consumption, as compared to processing functions that may not be cached. For example, payment processing functions or authentication functions may be cached at Edge servers for processing on customer owned personal mobile devices that may be used in conjunction with a smart point of sale device at a retail site, or for consumption on the Edge servers themselves.

In some cases, when business needs require hybrid data processing for example, Private User Information needs to be anonymized and stripped from privacy-related attributes prior to aggregation and forwarding to the second party processor (e.g., MNO) or third party processor (e.g., Credit Reporting Agency) for processing and generating the authorization assertion or weighted authorization score (e.g., FICO report). In one example, the processing of confidential/private information is performed at the highest security point in the business value chain (e.g., at data owner or data custodian). This may include a payment assertion generated at the POS or at the card itself by the virtualized payment processing function (VPPF). This may also be a virtualized authentication function (VAF) that is instantiated and executed at the VM on the users' device, which may be a mobile device, an IoT device, a wearable device, or smart card, for example. Such a VAF may be executed at the credentials owner or custodian premises, and may allow generation of the Authentication Assertion for either local or remote/network service use.

In some cases, VNFs, VPPFs, and VAFs from the examples above are owned and controlled by application service providers, and remotely instantiated at the VM provided by private/confidential data owner or custodian. It is recognized herein that there might be a need to cache VNFs, VPPFs, and VAFs, to make their instantiation more robust. For example, VPPFs for instantiation at customer smart cards may be cached at a POS device.

FIG. 9A is a diagram of an example communications system 50 in which one or more disclosed embodiments may be implemented. The communications system 50 may be a multiple access system that provides content, such as voice, data, video, messaging, broadcast, etc., to multiple wireless users. The communications system 50 may enable multiple wireless users to access such content through the sharing of system resources, including wireless bandwidth. For example, the communications systems 50 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 9A, the communications system 50 may include wireless transmit/receive units (WTRUs) 52a, 52b, 52c, 52d, a radio access network (RAN) 54, a core network 56, a public switched telephone network (PSTN) 58, the Internet 60, and other networks 62, though it will be appreciated that the disclosed embodiments contemplate any number of WTRUs, base stations, networks, and/or network elements. Each of the WTRUs 52a, 52b, 52c, 52d may be any type of device configured to operate and/or communicate in a wireless environment. By way of example, the WTRUs 52a, 52b, 52c, 52d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 50 may also include a base station 64a and a base station 64b. Each of the base stations 64a, 64b may be any type of device configured to wirelessly interface with at least one of the WTRUs 52a, 52b, 52c, 52d to facilitate access to one or more communication networks, such as the core network 56, the Internet 60, and/or the networks 62. By way of example, the base stations 64a, 64b may be a base transceiver station (BTS), a Node-B, an eNode B, a Home Node B, a Home eNode B, a site controller, an access point (AP), a wireless router, and the like. While the base stations 64a, 64b are each depicted as a single element, it will be appreciated that the base stations 64a, 64b may include any number of interconnected base stations and/or network elements.

The base station 64a may be part of the RAN 54, which may also include other base stations and/or network elements (not shown), such as a base station controller (BSC), a radio network controller (RNC), relay nodes, etc. The base station 64a and/or the base station 64b may be configured to transmit and/or receive wireless signals within a particular geographic region, which may be referred to as a cell (not shown). The cell may further be divided into cell sectors. For example, the cell associated with the base station 64a may be divided into three sectors. Thus, in an embodiment, the base station 64a may include three transceivers, i.e., one for each sector of the cell. In an embodiment, the base station 64a may employ multiple-input multiple output (MIMO) technology and, therefore, may utilize multiple transceivers for each sector of the cell.

The base stations 64a, 64b may communicate with one or more of the WTRUs 52a, 52b, 52c, 52d over an air interface 66, which may be any suitable wireless communication link (e.g., radio frequency (RF), microwave, infrared (IR), ultraviolet (UV), visible light, etc.). The air interface 66 may be established using any suitable radio access technology (RAT).

More specifically, as noted above, the communications system 50 may be a multiple access system and may employ one or more channel access schemes, such as CDMA, TDMA, FDMA, OFDMA, SC-FDMA, and the like. For example, the base station 64a in the RAN 54 and the WTRUs 52a, 52b, 52c may implement a radio technology such as Universal Mobile Telecommunications System (UMTS) Terrestrial Radio Access (UTRA), which may establish the air interface 816 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 64a and the WTRUs 52a, 52b, 52c may implement a radio technology such as Evolved UMTS Terrestrial Radio Access (E-UTRA), which may establish the air interface 66 using Long Term Evolution (LTE) and/or LTE-Advanced (LTE-A).

In other embodiments, the base station 64a and the WTRUs 52a, 52b, 52c may implement radio technologies such as IEEE 802.16 (i.e., Worldwide Interoperability for Microwave Access (WiMAX)), CDMA2000, CDMA2000 1x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 64b in FIG. 9A may be a wireless router, Home Node B, Home eNode B, femto cell base station, or access point, for example, and may utilize any suitable RAT for facilitating wireless connectivity in a localized area, such as a place of business, a home, a vehicle, a campus, and the like. In an embodiment, the base station 64b and the WTRUs 52c, 52d may implement a radio technology such as IEEE 802.11 to establish a wireless local area network (WLAN). In an embodiment, the base station 64b and the WTRUs 52c, 52d may implement a radio technology such as IEEE 802.15 to establish a wireless personal area network (WPAN). In yet an embodiment, the base station 64b and the WTRUs 52c, 52d may utilize a cellular-based RAT (e.g., WCDMA, CDMA2000, GSM, LTE, LTE-A, etc.) to establish a picocell or femtocell. As shown in FIG. 9A, the base station 64b may have a direct connection to the Internet 60. Thus, the base station 64b may not be required to access the Internet 60 via the core network 56.

The RAN 54 may be in communication with the core network 56, which may be any type of network configured to provide voice, data, applications, and/or voice over internet protocol (VoIP) services to one or more of the WTRUs 52a, 52b, 52c, 52d. For example, the core network 56 may provide call control, billing services, mobile location-based services, pre-paid calling, Internet connectivity, video distribution, etc., and/or perform high-level security functions, such as user authentication. Although not shown in FIG. 9A, it will be appreciated that the RAN 54 and/or the core network 56 may be in direct or indirect communication with other RANs that employ the same RAT as the RAN 54 or a different RAT. For example, in addition to being connected to the RAN 54, which may be utilizing an E-UTRA radio technology, the core network 56 may also be in communication with another RAN (not shown) employing a GSM radio technology.

The core network 56 may also serve as a gateway for the WTRUs 52a, 52b, 52c, 52d to access the PSTN 58, the Internet 60, and/or other networks 62. The PSTN 58 may include circuit-switched telephone networks that provide plain old telephone service (POTS). The Internet 60 may include a global system of interconnected computer networks and devices that use common communication protocols, such as the transmission control protocol (TCP), user datagram protocol (UDP) and the internet protocol (IP) in the TCP/IP internet protocol suite. The networks 62 may include wired or wireless communications networks owned and/or operated by other service providers. For example, the networks 62 may include another core network connected to one or more RANs, which may employ the same RAT as the RAN 54 or a different RAT.

Some or all of the WTRUs 52a, 52b, 52c, 52d in the communications system 800 may include multi-mode capabilities, i.e., the WTRUs 52a, 52b, 52c, 52d may include multiple transceivers for communicating with different wireless networks over different wireless links. For example, the WTRU 52c shown in FIG. 9A may be configured to communicate with the base station 64a, which may employ a cellular-based radio technology, and with the base station 64b, which may employ an IEEE 802 radio technology.

FIG. 9B is a system diagram of an example WTRU 52. As shown in FIG. 9B, the WTRU 52 may include a processor 68, a transceiver 70, a transmit/receive element 72, a speaker/microphone 74, a keypad 76, a display/touchpad 78, non-removable memory 80, removable memory 82, a power source 84, a global positioning system (GPS) chipset 86, and other peripherals 88. It will be appreciated that the WTRU 52 may include any sub-combination of the foregoing elements while remaining consistent with an embodiment.

The processor 68 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 68 may perform signal coding, data processing, power control, input/output processing, and/or any other functionality that enables the WTRU 52 to operate in a wireless environment. The processor 68 may be coupled to the transceiver 70, which may be coupled to the transmit/receive element 72. While FIG. 9B depicts the processor 68 and the transceiver 70 as separate components, it will be appreciated that the processor 68 and the transceiver 70 may be integrated together in an electronic package or chip. The processor 68 may perform application-layer programs (e.g., browsers) and/or radio access-layer (RAN) programs and/or communications. The processor 68 may perform security operations such as authentication, security key agreement, and/or cryptographic operations, such as at the access-layer and/or application layer for example.

The transmit/receive element 72 may be configured to transmit signals to, or receive signals from, a base station (e.g., the base station 64a) over the air interface 66. For example, in an embodiment, the transmit/receive element 72 may be an antenna configured to transmit and/or receive RF signals. In an embodiment, the transmit/receive element 72 may be an emitter/detector configured to transmit and/or receive IR, UV, or visible light signals, for example. In yet an embodiment, the transmit/receive element 72 may be configured to transmit and receive both RF and light signals. It will be appreciated that the transmit/receive element 72 may be configured to transmit and/or receive any combination of wireless signals.

In addition, although the transmit/receive element 72 is depicted in FIG. 9B as a single element, the WTRU 52 may include any number of transmit/receive elements 72. More specifically, the WTRU 52 may employ MIMO technology. Thus, in an embodiment, the WTRU 52 may include two or more transmit/receive elements 72 (e.g., multiple antennas) for transmitting and receiving wireless signals over the air interface 66.

The transceiver 70 may be configured to modulate the signals that are to be transmitted by the transmit/receive element 72 and to demodulate the signals that are received by the transmit/receive element 72. As noted above, the WTRU 52 may have multi-mode capabilities. Thus, the transceiver 70 may include multiple transceivers for enabling the WTRU 52 to communicate via multiple RATs, such as UTRA and IEEE 802.11, for example.

The processor 68 of the WTRU 52 may be coupled to, and may receive user input data from, the speaker/microphone 74, the keypad 76, and/or the display/touchpad 78 (e.g., a liquid crystal display (LCD) display unit or organic light-emitting diode (OLED) display unit). The processor 68 may also output user data to the speaker/microphone 74, the keypad 76, and/or the display/touchpad 78. In addition, the processor 818 may access information from, and store data in, any type of suitable memory, such as the non-removable memory 80 and/or the removable memory 82. The non-removable memory 80 may include random-access memory (RAM), read-only memory (ROM), a hard disk, or any other type of memory storage device. The removable memory 82 may include a subscriber identity module (SIM) card, a memory stick, a secure digital (SD) memory card, and the like. In other embodiments, the processor 818 may access information from, and store data in, memory that is not physically located on the WTRU 52, such as on a server or a home computer (not shown).

The processor 68 may receive power from the power source 84, and may be configured to distribute and/or control the power to the other components in the WTRU 52. The power source 84 may be any suitable device for powering the WTRU 52. For example, the power source 84 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 68 may also be coupled to the GPS chipset 86, which may be configured to provide location information (e.g., longitude and latitude) regarding the current location of the WTRU 52. In addition to, or in lieu of, the information from the GPS chipset 86, the WTRU 52 may receive location information over the air interface 816 from a base station (e.g., base stations 64a, 64b) and/or determine its location based on the timing of the signals being received from two or more nearby base stations. It will be appreciated that the WTRU 52 may acquire location information by way of any suitable location-determination method while remaining consistent with an embodiment.

The processor 68 may further be coupled to other peripherals 88, which may include one or more software and/or hardware modules that provide additional features, functionality and/or wired or wireless connectivity. For example, the peripherals 88 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 9C is a system diagram of the RAN 54 and the core network 806 according to an embodiment. As noted above, the RAN 54 may employ a UTRA radio technology to communicate with the WTRUs 52a, 52b, 52c over the air interface 66. The RAN 54 may also be in communication with the core network 806. As shown in FIG. 9C, the RAN 54 may include Node-Bs 90a, 90b, 90c, which may each include one or more transceivers for communicating with the WTRUs 52a, 52b, 52c over the air interface 66. The Node-Bs 90a, 90b, 90c may each be associated with a particular cell (not shown) within the RAN 54. The RAN 54 may also include RNCs 92a, 92b. It will be appreciated that the RAN 54 may include any number of Node-Bs and RNCs while remaining consistent with an embodiment.

As shown in FIG. 9C, the Node-Bs 90a, 90b may be in communication with the RNC 92a. Additionally, the Node-B 90c may be in communication with the RNC 92b. The Node-Bs 90a, 90b, 90c may communicate with the respective RNCs 92a, 92b via an Iub interface. The RNCs 92a, 92b may be in communication with one another via an Iur interface. Each of the RNCs 92a, 92b may be configured to control the respective Node-Bs 90a, 90b, 90c to which it is connected. In addition, each of the RNCs 92a, 92b may be configured to carry out and/or support other functionality, such as outer loop power control, load control, admission control, packet scheduling, handover control, macrodiversity, security functions, data encryption, and the like.

The core network 806 shown in FIG. 9C may include a media gateway (MGW) 844, a mobile switching center (MSC) 96, a serving GPRS support node (SGSN) 98, and/or a gateway GPRS support node (GGSN) 99. While each of the foregoing elements are depicted as part of the core network 56, it will be appreciated that any one of these elements may be owned and/or operated by an entity other than the core network operator.

The RNC 92a in the RAN 54 may be connected to the MSC 96 in the core network 56 via an IuCS interface. The MSC 96 may be connected to the MGW 94. The MSC 96 and the MGW 94 may provide the WTRUs 52a, 52b, 52c with access to circuit-switched networks, such as the PSTN 58, to facilitate communications between the WTRUs 52a, 52b, 52c and traditional land-line communications devices.

The RNC 92a in the RAN 54 may also be connected to the SGSN 98 in the core network 806 via an IuPS interface. The SGSN 98 may be connected to the GGSN 99. The SGSN 98 and the GGSN 99 may provide the WTRUs 52a, 52b, 52c with access to packet-switched networks, such as the Internet 60, to facilitate communications between and the WTRUs 52a, 52b, 52c and IP-enabled devices.

As noted above, the core network 56 may also be connected to the networks 62, which may include other wired or wireless networks that are owned and/or operated by other service providers.

Although features and elements are described above in particular combinations, each feature or element can be used alone or in any combination with the other features and elements. Additionally, the embodiments described herein are provided for exemplary purposes only. For example, while embodiments may be described herein using OpenID and/or SSO authentication entities and functions, similar embodiments may be implemented using other authentication entities and functions. Furthermore, the embodiments described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A node communicatively coupled with a network via communication circuitry, the node comprising:
a processor and a memory, the memory containing computer-executable instructions that when executed by the processor, cause the processor to perform operations comprising:
receiving a request, from a network entity, for a result that requires at least one processing function to be performed on data, wherein at least some of the data is stored on a data node, and the data that is stored on the data node is controlled by a plurality of control nodes, such that each control node controls a respective portion of the data;
receiving a respective processing function from each of the plurality of control nodes, each processing function being associated with a respective control node, and each processing function defining at least one computation performed on data;
performing each of the processing functions on the respective portion of data that is controlled by the control node associated with the processing function;
determining a result based on the processing functions; and
sending the result to the network entity.

2. The node as recited in claim 1, wherein the processing functions comprise at least one of a Java Applet, a remote procedure call, or a virtual network function.

3. The node as recited in claim 1, wherein the memory contains further computer-executable instructions that when executed by the processor, cause the processor to perform further operations comprising:
receiving user data from a user of the node, such that at least one of the processing functions is also performed on the user data.

4. The node as recited in claim 1, wherein the memory contains further computer-executable instructions that when executed by the processor, cause the processor to perform further operations comprising:
sending the result to the network entity without transferring any of the data used to determine the result.

5. The node as recited in claim 1, wherein the memory contains further computer-executable instructions that when executed by the processor, cause the processor to perform further operations comprising:
retrieving the data stored on the data node from the data node.

6. The node as recited in claim 1, wherein the result is a credit check result.

7. The node as recited in claim 1, wherein the node includes the data node.

8. A method for protecting data, the method comprising:
receiving a request, from a network entity, for a result that requires at least one processing function to be performed on the data, wherein at least some of the data is stored on a data node, and the data that is stored on the data node is controlled by a plurality of control nodes, such that each control node controls a respective portion of the data;
receiving a respective processing function from each of the plurality of control nodes, each processing function being associated with a respective control node, and each processing function defining at least one computation performed on data;
performing each of the processing functions on the respective portion of data that is controlled by the control node associated with the processing function;
determining a result based on the processing functions; and
sending the result to the network entity.

9. The method as recited in claim 8, wherein the processing functions comprise at least one of a Java Applet, a remote procedure call, or a virtual network function.

10. The method as recited in claim 8, wherein the method is performed at a user equipment having a user, the method further comprising:
receiving user data from the user of the user equipment, such that at least one of the processing functions is also performed on the user data.

11. The method as recited in claim 8, the method further comprising:
sending the result to the network entity without transferring any of the data used to determine the result.

12. The method as recited in claim 8, the method further comprising:
retrieving the data stored on the data node from the data node.

13. The method as recited in claim 8, wherein the result is a credit check result.

14. The method as recited in claim 8, wherein the method is performed at a node that includes the data node.

15. A user equipment communicatively coupled with a network via communication circuitry, the node comprising:
a processor and a memory, the memory containing computer-executable instructions that when executed by the processor, cause the processor to perform operations comprising:
receiving data associated with a user of the user equipment;
sending an authorization request to a network node without sending the data to the network node;
based on the authorization request, receiving a virtual authorization function, wherein the virtual authorization function defines at least one computation performed on data; and
computing an authorization assertion using the virtual authorization function and the data.

16. The user equipment as recited in claim 15, wherein the data is received from the user of the user equipment.

17. The user equipment node as recited in claim 15, wherein the authorization assertion indicates the result of a credit check.
